(19) United States
(12) Patent Application Publication
(10) Pub. No.: US 2026/0088267 A1
(43) Pub. Date: Mar. 26, 2026

(54) EXCIMER LAMP

(71) Applicant: ORC MANUFACTURING CO., LTD., Tokyo (JP)

(72) Inventors: Go KOBAYASHI, Tokyo (JP); Izumi SERIZAWA, Tokyo (JP); Takashi FUKUDA, Tokyo (JP)

(73) Assignee: ORC MANUFACTURING CO., LTD., Tokyo (JP)

(21) Appl. No.: 19/329,941

(22) Filed: Sep. 16, 2025

(30) Foreign Application Priority Data
Sep. 20, 2024 (JP) 2024-164317

(51) Int. Cl. H01J 61/32; H01J 61/06; H01J 61/12

(52) U.S. Cl. CPC H01J 61/32; H01J 61/06; H01J 61/12

(57) ABSTRACT

An excimer lamp includes a tubular discharge vessel configured to form a discharge space, and an exterior vessel configured to form a channel between said discharge vessel and said exterior vessel. At least one end of said channel is on a lamp-center side relative to the end of said discharge vessel in a lamp axis direction.

### BACKGROUND OF THE INVENTION

### 1. Field of the Invention

The present invention relates to an excimer lamp.

### 2. Description of the Related Art

In an excimer lamp, a discharge gas is sealed in a discharge tube and electrodes that are opposite one another are arranged along the axis of the discharge tube. A discharge occurs by applying high-frequency electrical current and high_voltage between the electrodes so that excimer light, i.e., ultraviolet light irradiates an object such as a gas or liquid. For example, ultraviolet light irradiates a source gas for generating ozone.

In a UV irradiation device or ozone-generating device with an excimer lamp, ultraviolet light should be effectively radiated into a channel in which a gas or liquid flows. Ogelschatz et al. (U.S. Pat. No. 5,194,740) discloses a UV irradiation device in which a UV light irradiation space is formed around a discharge tube. The UV irradiation device has an exterior tube that surrounds the discharge tube and is coaxial to the discharge tube. An object to be irradiated, such as water, flows in an annular space formed between the discharge tube and the exterior tube.

### SUMMARY OF THE INVENTION

The present invention is directed to an improvement of an excimer lamp with treatment space.

An excimer lamp according to the present invention includes: a tubular discharge vessel configured to form a discharge space, and an exterior vessel configured to form a channel between said discharge vessel and said exterior vessel. At least one end of said channel is on a lamp-center side relative to the end of said discharge vessel in the lamp axis direction.

### BRIEF DESCRIPTION OF THE DRAWINGS

The present invention will be better understood from the description of the preferred embodiments of the invention set forth below together with the accompanying drawings, in which:

FIG. 1 is a schematic cross-section view of an excimer lamp according to a first embodiment;

FIG. 2 is a cross-section view along line II-II shown in FIG. 1;

FIG. 3 is a cross-section view of an excimer lamp according to the second embodiment;

FIG. 4 is a cross-section view of an excimer lamp according to the third embodiment;

FIG. 5 is a cross-section view of an excimer lamp according to the fourth embodiment;

FIG. 6 is a cross-section view of an excimer lamp according to the fifth embodiment; and

FIG. 7 is a cross-section view of an excimer lamp according to the sixth embodiment.

### DESCRIPTION OF THE PREFERRED EMBODIMENTS

Hereinafter, the preferred embodiments of the present invention are described with references to the attached drawings.

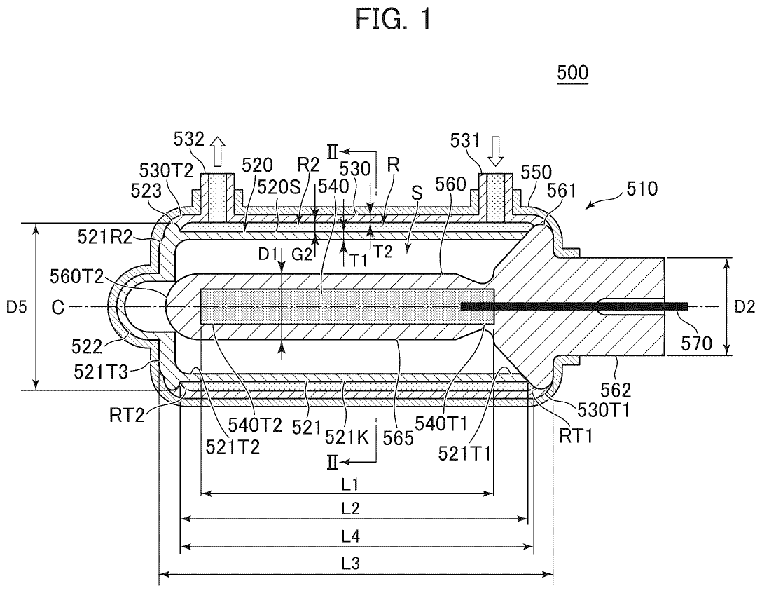

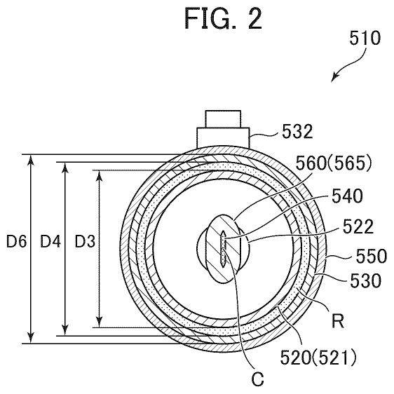

FIG. 1 is a schematic cross-section view of an excimer lamp according to a first embodiment. FIG. 2 is a cross-section view along the II-II line shown in FIG. 1.

The excimer lamp 510 is incorporated into a UV irradiation device 500. The excimer lamp 510 is connected to an electric power supply (not shown) via a power supply rod or wire 70. The excimer lamp 510 is equipped with a tubular discharge vessel 520 and a vessel for treating a gas or liquid (hereinafter, called “exterior vessel”) 530, which are welded together. Herein, gas such as air or liquid such as water is supplied to the UV irradiation device 500 as an object to be irradiated. The supplied gas or liquid flows in a channel R that is formed between the discharge vessel 520 and the exterior vessel 530. The UV irradiation device 500 is a module-type unit, which may be incorporated into an ozonizing unit, a deodorizing unit, and so on.

The discharge vessel 520 is composed of dielectric materials such as a quartz glass. An electrode (hereinafter, called “inner electrode”) 540 is arranged along the lengthwise tubular axis C of the discharge vessel 520 (hereinafter, called “lamp axis”) in the discharge vessel 520, i.e., the excimer lamp 510. The inner electrode 540 is herein a foil electrode, which extends along the lamp axis C and one end 540T1 of the inner electrode 540 connects with the power supply rod or wire 70.

The inner electrode 540 is covered with a dielectric 560 such as quartz glass. The inner electrode 540 is embedded in the dielectric 560 such that the inner electrode 540 is not exposed to a discharge space S formed in the discharge vessel 520. The dielectric 560 extends along the lamp axis C and its cross-sectional diameter expands from the end 540T1 of the inner electrode 540. A diameter-enlarged segment 561 is hereinafter called a “tapered segment”.

The discharge vessel 520 has a cylindrical tube with a bottom (hereinafter, called a “tubular segment”) 521. The end 521T1 of the tubular segment 521 is welded adjacent to the end of the tapered segment 561. A noble gas such as a xenon gas or a mixture of a noble gas and a halogen gas is sealed into the discharge space S between the tubular segment 521 and the dielectric 560 as a discharge gas.

The tubular segment 521 has a bottom 521T3 and a cylindrical segment 521K with a constant diameter along the lamp axis C. The tubular segment 521, furthermore, has a shoulder segment 521R2 in which the diameter decreases from the end 521T2 of the cylindrical segment 521K toward the tip surface 521T3 of the tubular segment 521. In the tip surface 521T3, a tubular protrusion (hereinafter, called an “exhaust tube”) 522 is formed along the lamp axis C. The tip 560T2 of the dielectric 560 protrudes into the inner space of the exhaust tube 522.

In the shoulder segment 521R2, a protrusion or flange 523 is formed circumferentially (hereinafter, called a “large-diameter part”). The large diameter part 523 has a diameter and thickness greater than the rest of the tubular segment 521 and extends outward from the inner surface of the exterior vessel 530 in a radial direction. The outer diameter D5 of the large diameter part 523 is greater than the inner diameter D4 of the exterior vessel 530 and less than the outer diameter D6 of the exterior vessel 530.

The dielectric 360 has an extending segment 562 that extends from the tapered segment 561 toward the end of the excimer lamp 10 along the lamp axis C. The extending segment 562 covers the power supply rod or wire 70.

The exterior vessel 530 is composed of a quartz glass, similar to the discharge vessel 520. One end of the exterior vessel 530T1 is welded to the end of the tapered segment 561 of the dielectric 560. The other end 530T2 of the exterior vessel 530 is welded to the large diameter part 523. The discharge vessel 520 is arranged coaxially inside of the exterior vessel 530. The ends of the exterior vessel 530T1 and 530T2 correspond to the channel ends RT1 and RT3.

The discharge vessel 520 and the exterior vessel 530 are covered with a reflective membrane 550 that reflects ultraviolet light. The reflective membrane 550 covers the total of the exterior vessel 530, the discharge vessel 520 including the exhaust tube 522, and part of the extending segment 562. The reflective membrane 550, which functions an outer electrode, is constructed of a pair of electrodes with an inner electrode 540 in the discharge vessel 520. For example, the reflective membrane 550 is composed of an aluminum membrane.

The pair of electrodes, i.e., the inner electrode 540 and the reflective membrane 560, are opposite one another within a section L1 along the lamp axis C (hereinafter, called an “electrode-opposing section”). The outer diameter D2 of the extending segment 562 is larger than the outer diameter D1 of a segment 565 (hereinafter, called a “small-diameter segment”) that corresponds to the electrode-opposing section L1 and covers the inner electrode 540.

One end of the channel RT2, i.e., the exterior vessel end 530T2, is on the lamp-center side relative to the tip surface 521T3 of the tubular segment 521 along the lamp axis C. The position of the channel end RT2 is within a section L3 along the lamp axis C. The section L3 represents a section from the shoulder segment 521R2 in the tubular segment 521 to the tapered segment 561 in the dielectric 560. The section L3 is hereinafter called a “vessel body section”. The position of the channel end RT2 is outside of the electrode-opposing section L1.

The other end of the channel RT1, i.e., the end 530T1 of the exterior vessel 530, is on the lamp-center side relative to the end of the tapered segment 561 along the lamp axis C. The position of the channel end RT1 is within the vessel body section L3. The length of the channel R is longer than the electrode-opposing section L1 and shorter than the vessel body section L3.

The exterior vessel 530 has an inlet (channel tube) 531 and an outlet (channel tube) 532. A gas or liquid enters from a pipe (not shown) into the inlet 531, flows along in a direction from the channel end RT1 to the channel end RT2, and exits from the outlet 532. A gas or liquid flows in the channel R continuously or intermittently. A flow velocity or an amount of flow may be adjusted by an arbitrary method. For example, a flow velocity is adjusted in accordance to the intensity of ultraviolet light. The direction of the flow of a gas or liquid may be reversed, i.e., a gas or liquid may flow in the channel R from the outlet 532 toward the inlet 531. Herein, the inlet 531 and the outlet 532 face the same direction. However, the inlet 531 and the outlet 532 may face different directions (e.g., opposite directions), respectively.

The outlet 532 is formed at the lamp-center side relative to the large diameter part 523 and adjacent to the channel end RT2. The outlet 532 is opposite to the end of the inner electrode 540T2. Note that the outlet 532 may be formed at a position that is opposite to the end of the dielectric 560T2.

As shown in FIG. 2, the inner electrode 540 and the dielectric 560 are coaxial to the discharge vessel 520, and the exterior vessel 530 is also coaxial to the discharge vessel 520. The channel R has a cylindrical or annular region R2 in which a spatial distance G2 in the radial direction is constant along the lamp axis C.

As for the inner electrode 540, a rod or plate shaped electrode may be applied. Also, the inner electrode 540 may be exposed partially or totally to the discharge space S.

The polarities of the inner electrode 540 and the reflective membrane 550 are herein set to an anode and a cathode, respectively. A high frequency current (for example, a frequency within the range of several kilohertz to a dozen kilohertz) and a high voltage (for example, a voltage within the range of several kilovolts to a dozen kilovolts) is supplied to the inner electrode 540 and the reflective membrane 550. Consequently, a dielectric barrier discharge occurs between the inner electrode 540 and the reflective membrane 550, and excimer light (ultraviolet light) having a specific spectrum (e.g., 172 nm) is emitted from the discharge space S.

The cylindrical region R2 in the channel R, which is formed around the cylindrical segment 521K, has a cylindrical and annular-shaped space where the spatial distance G2 is constant in the radial direction. Ultraviolet light is emitted from the discharge vessel 520 circumferentially to effectively irradiate a gas or liquid in the channel R. In addition, the reflective membrane 550, which is in close contact with the exterior vessel 530, reflects ultraviolet light that passes through the exterior vessel 530 to enhance the efficiency of luminescence and reflection of ultraviolet light.

Furthermore, the emitted ultraviolet light is transmitted through the inside of the dielectric 560, the vessel body segment 521 of the discharge vessel 520 and the exterior vessel 530. Since the discharge vessel 520 and the exterior vessel 530 are quartz glass and unified, emitted ultraviolet light can be transmitted to the inside of the exterior vessel 530 by multiple reflections. The multiple reflections allow ultraviolet light to irradiate a gas or liquid from all directions.

The excimer lamp according 510 to the first embodiment is a micro excimer lamp that is miniaturized or downsized. For example, the length of the discharge vessel 520 may be set to a range between 20-400 mm. The outer diameter of the discharge vessel 520 may be set to a range between 6-30 mm, preferably between 8-25 mm.

To prevent the discharge tube 520 from degrading due to excimer light emission and increasing in voltage for starting discharge, the thickness of the discharge vessel 520 may be set to a range between 0.7-2.0 mm. As for the inner diameter of the discharge vessel 520, to prevent the excimer lamp 500 from experiencing either unstable discharge due to a long discharge distance or shortage of illumination due to a short discharge distance, the inner diameter may be set to a range between 4-28 mm, preferably between 5-23 mm.

The discharge distance in the discharge vessel 520, i.e., the distance between the outer surface of the dielectric 560 and the inner surface of the discharge vessel 520, may be set to a range between 1-13 mm, and preferably between 2-12 mm to prevent the excimer lamp 510 from experiencing either a shortage of illumination due to a limited discharge space or unstable discharge due to an excessive discharge distance.

The size and shape of the exterior vessel 530 depends on the intensity of ultraviolet light, characteristics of the flow of gas or liquid passing through the channel R (e.g., flow velocity, amount of flow and stress), the size of the discharge vessel 520 (e.g., the outer diameter D3 of the vessel body segment) and the outer diameter D6 of the exterior vessel 530.

For example, the thickness T1 of the vessel body segment 521 may be set to a range between 0.7 mm-2.0 mm. The thickness T2 of the exterior vessel 530 may be set to a range between 0.5 mm-3.0 mm. The size of the cylindrical space R2, namely, the distance R2 between the outer surface of the cylindrical segment 521K in the discharge vessel 520 and the inner surface of the exterior vessel 530 may be set to a range between 0.2 mm-6.0 mm, preferably between 0.2 mm-2.0 mm.

As described above, the exterior vessel 530 is welded to the large diameter part 523 and the tapered segment 561 so that the exterior vessel 530 is coaxial to the discharge vessel 520. Thus, even if the spatial distance G2 of the cylindrical domain R2 is smaller than the thickness T1 of the discharge vessel 520 or the thickness T2 of the exterior vessel 530, the exterior vessel 530 can be coaxial to the discharge vessel 520 accurately.

The spatial distance G2 of the cylindrical domain R2 in a radial direction is constant circumferentially, which suppresses turbulence in the channel R and enables the emission of ultraviolet light without attenuation to irradiate a gas or liquid. Furthermore, since the large diameter part 523 and the tapered segment 561, which are thicker than the other parts, are adjacent to the channel ends RT1 and RT2, the likelihood of lamp breakage starting from a welded part is suppressed even if an abrupt change of pressure occurs when adjusting flow velocity.

The positions of the channel ends RT1 and RT2 along the lamp axis C depend upon the position of the welded part between the discharge vessel 520 and the exterior vessel 530 or the dielectric 560. The positions of the inlet 531 and the outlet 532 may be set in accordance to the electrode-opposing section L1.

The large diameter part 523 has a curved surface and the thickness of the large diameter part 523 varies with respect to length. The end 530T2 of the exterior vessel 530 is welded to the large diameter part 523 so that the outer surface of the exterior vessel 530 is in continuous contact with the outer surface of the discharge vessel 520. This enhances mechanical strength and suppresses the occurrence of a minute wedged gap in a welded part, which could cause lamp breakage. As a result, the reflective membrane 550 can tightly cover the outer surface of the welded part. Note that the outer surface of the welded part of the tapered segment 561 and the end of the exterior vessel 530T1 may be a curved surface.

The excimer lamp 510 explained above can be manufactured by the following manufacturing process.

Firstly, a flange portion is formed at one end of a first cylindrical quartz glass tube with open ends such that the diameter of the flange is larger than the inner surface of a second cylindrical quartz glass tube with open ends. The first glass tube corresponds to the discharge vessel 520 and the second glass tube corresponds to the exterior vessel 530. A tube for exhausting gas is also formed at one end of the first glass tube.

Next, a dielectric that covers a foil electrode and has a tapered segment as shown in FIG. 1 is inserted into the other end of the first glass tube. Currently, the tip of the dielectric reaches the inside of the exhaust tube. The end of the tapered segment in the dielectric has a maximum diameter that is larger or smaller than the inner diameter of the second glass tube. After the insertion of the dielectric, the other end of the first glass tube is welded to the tapered segment in the dielectric to form a discharge vessel.

An inlet and outlet are formed in the second glass tube and the first glass tube is inserted into the second glass, tube. Currently, the flange of the first glass tube makes contact or engages with one end of the second glass tube. The flange supports the end of the second glass tube to arrange the second glass tube coaxially and temporarily secure the second glass tube. Then, the ends of the second glass tube are welded to the flange of the first glass tube and the tapered segment in the dielectric. Note that the tapered segment in the dielectric may support the second glass tube before the second glass tube is welded in place.

The welded first and second glass tubes are subjected to a vacuum process via the exhaust tube to remove impurities and a discharge gas is supplied to the welded tubes. Then, the exhaust tube is heated to weld and seal it to the inside of the first glass tube. After the sealing process, the sealed tubes are covered with a reflective membrane.

During the above manufacturing process, no exterior supporting member is provided in either the first or second glass tubes. Thus, ultraviolet light emitted from the discharge vessel 520 travels through the channel circumferentially.

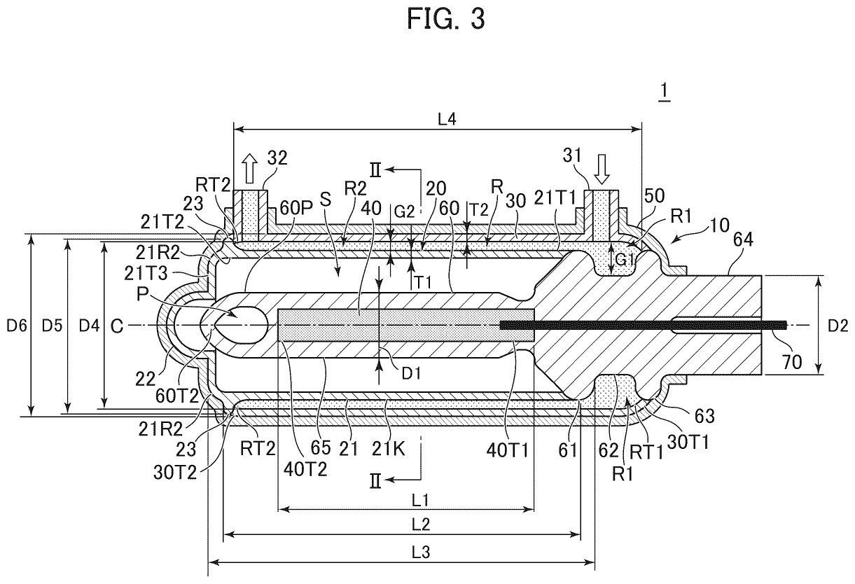

FIG. 3 is a cross-section view of an excimer lamp according to the second embodiment.

An excimer lamp 10 is incorporated into a UV irradiation device 1 and connected to an electric power supply (not shown) via a power supply rod or wire 70. The excimer lamp 10 is equipped with a tubular discharge vessel 20 and an exterior vessel 30, which are welded to one another and unified. A channel R is formed between the discharge vessel 20 and the exterior vessel 30. A dielectric 60 covers an inner electrode 40 and is coaxially arranged in the discharge vessel 30 along the lamp axis C.

The dielectric 60 has an unsealed tip segment 60P between the tip 60T2 of the dielectric 60 and the tip 40T2 of the inner electrode 40. In the unsealed tip segment 60P, an auxiliary discharge space P for starting illumination is formed. The pressure of the auxiliary discharge space S is reduced and a noble gas with a pressure less than atmospheric pressure may be sealed inside the auxiliary discharge space S.

The discharge vessel 20 has a tubular segment 21, which is constructed of a tip surface 21T3, a cylindrical segment 21K and a shoulder segment 21R2. The discharge vessel 20 also has an exhaust tube 22 along the lamp axis C. The dielectric 60 has a tapered segment 61 and an extending segment 62. The end 21T1 of the tubular segment 21 is welded to the tapered segment 61 of the dielectric 60.

The extending segment 62 of the dielectric 60 has a protrusion or flange 63 that protrudes radially and has a diameter larger than the diameters of the other sections of the dielectric 60 (hereinafter, called a “flange segment”). The end 30T1 of the exterior vessel 30 is welded to the flange segment 63 to form the end RT1 of the channel R.

In the cylindrical segment 21K, a protrusion 23 is formed (hereinafter, called a “large diameter part”). The large-diameter part 23 has a diameter and thickness greater than the other parts of the cylindrical segment 21K. The outer diameter D5 of the large-diameter part 23 is greater than the inner diameter D4 of the exterior vessel 530 and less than the outer diameter D6 of the exterior vessel 30.

The discharge vessel 20 and the exterior vessel 30 are covered with a reflective membrane 50 that reflects ultraviolet light. The reflective membrane 50 covers the total of the discharge vessel 20, the exterior vessel 30 and an exposed segment 64 of the extending segment 62. In the dielectric 60, the diameter D2 of the extending segment 62 including the exposed segment 64 is greater than the small-diameter segment in which the diameter D1 of a dielectric 60 covers the inner electrode 40.

One end RT2 of the channel R is on the lamp-center side relative to the tip surface 21T3 of the discharge vessel 20 along the lamp axis C. The position of the channel end RT2 is within a vessel body section L3. Herein, the channel end RT2 is on the lamp-center side relative to the end 21T2 of the cylindrical segment 21K. The channel end RT2 is within the vessel body section L3 and outside of an electrode-opposing section L1. The channel end RT2 is on the lamp-end side relative to the end 40T2 of the inner electrode 40.

The other end RT1 of the channel R is on the lamp-end side relative to the end of the tapered segment 61 and outside of the vessel body section L3. The length of the channel L4 is longer than the vessel body section L3.

An inlet 31 is formed adjacent to the channel end RT1. The channel end RT1 is on the lamp-end side relative to the cylindrical segment 21K along the lamp axis C and outside of the vessel body section L3. Also, the channel end RT1 is on the lamp-end side relative to the tapered segment 61 and outside of the tubular section L3. The channel end RT1 faces an enlarged domain R1 in the channel R. The enlarged domain R1 is formed between the tapered segment 61 and the flange segment 63, and the cross-sectional area of the enlarged domain R1 is larger than the other cross-sectional areas in the channel R. The spatial distance G2 in the radial direction of the enlarged domain R1 is greater than the distance G1 of the annular domain R2.

An outlet 32 is formed on the exterior vessel 30 adjacent to the channel end RT2. The outlet 32 is on the lamp-center side relative to the large-diameter part 23. The outlet 32 faces the auxiliary discharge space P.

The excimer lamp 10 can be manufactured by a manufacturing method explained in the first embodiment. In this case, a second glass tube corresponding to the exterior vessel 30 is temporarily supported by a flange formed on a first glass tube corresponding to the discharge vessel 20 and is then welded to the flange. Thus, the discharge vessel 20 can be coaxially arranged with respect to the exterior vessel 30.

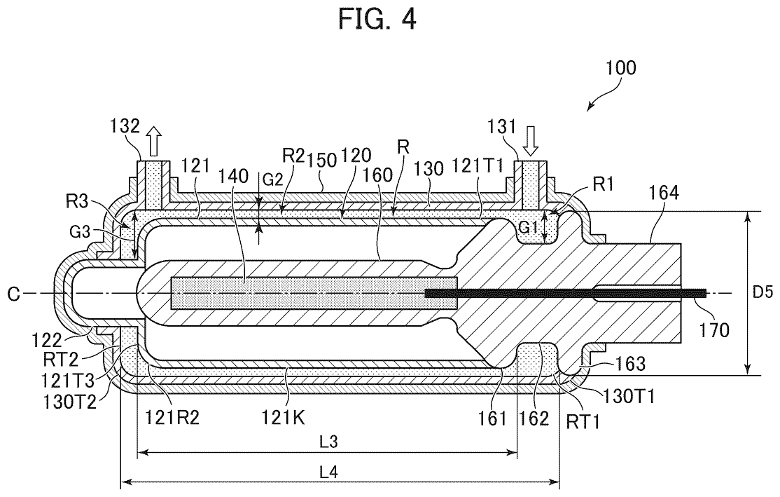

FIG. 4 is a cross-section view of an excimer lamp according to the third embodiment.

The excimer lamp 100 is equipped with a discharge vessel 120 and an exterior vessel 130. A dielectric 160, which covers an inner electrode 140, is coaxially arranged in the discharge vessel 120. The discharge vessel 120 has a tubular segment 121 and an exhaust tube 122. The dielectric 160 has a tapered segment 161, an extending segment 162 and a flange segment 163, similar to the second embodiment. The diameter D5 of the extending segment 162 is greater than the outer diameter of the circular segment 121K and the inner diameter of the exterior vessel 130, but preferably less than the outer diameter of the exterior vessel 130.

One end 130T1 of exterior vessel 130 is welded to the flange segment 163 of the discharge vessel 120 and the other end 130T2 is welded to the exhaust tube 122 formed in the discharge vessel 120. The welded positions are adjacent to the channel ends RT1 and RT2.

In the third embodiment, an enlarged region R1 is formed adjacent to the inlet 131 formed on the exterior vessel 130, and an enlarged region R3 is formed adjacent to the outlet 132. The enlarged region R3 is outside of the cylindrical segment 121K.

The enlarged region R3 is surrounded by the outer surface of the exhaust tube 122, the end 121T3 of the tubular segment 121, the outer surface of the shoulder segment 121R2 and the inner surface of the exterior vessel 130. The spatial distance G3 of the enlarged region R3 in the radial direction, i.e., the distance between the inner surface of the exterior vessel 130 and the outer surface of the exhaust tube 122, is greater than the spatial distance G2 of the cylindrical domain R2.

In the third embodiment, the channel R has the enlarged domains R3 neighboring the discharge space S and the length L4 of the channel R is longer than the vessel body section L3. Thus, ultraviolet light that is emitted from the tip surface 121T3 of the discharge vessel 120 effectively irradiates a gas or liquid in the enlarged region R3. The shoulder segment 121R2 in the discharge vessel 120 may be welded to the end 130T2 of the exterior vessel 130, as shown in FIG. 1.

Similarly to the manufacturing process of the second embodiment and before welding, a second glass tube corresponding to the exterior vessel 130 is supported by a flange formed on a first glass tube, which corresponds to the discharge vessel.

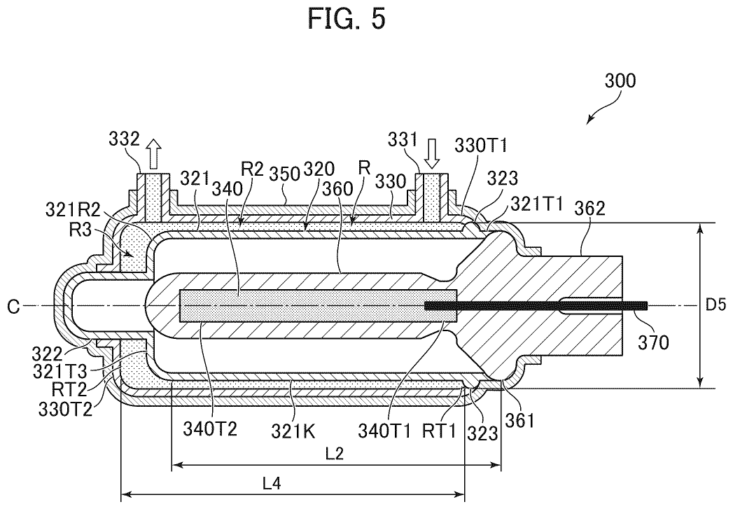

FIG. 5 is a cross-section view of an excimer lamp according to the fourth embodiment.

The excimer lamp 300 is equipped with a discharge vessel 120 and an exterior vessel 330. A dielectric 360, which covers an inner electrode 340, is coaxially arranged in the discharge vessel 320. The discharge vessel 320 has a tubular segment 321 and an exhaust tube 322. The dielectric 360 has a tapered segment 361 and an extending segment 362. The end 321T1 of the tubular segment 321 is welded to the tapered segment 361 of the dielectric 360. The discharge vessel 320 and the exterior vessel 330 are covered with a reflective membrane 350.

In the cylindrical segment 321K, a radially protruding protrusion or flange 323 is formed (herein after, called a “large-diameter part”). The outer diameter D5 of the large-diameter part 323 is greater than the inner diameter of the exterior vessel 330 and less than the outer diameter of the exterior vessel 330. One end 330T1 of the exterior vessel 330 is welded to the large-diameter part 323 to form the channel end RT1. The other end 330T2 is welded to the exhaust tube 322 to form the channel end RT2.

In the exterior vessel 330, an inlet 331 is formed on the lamp-center side relative to the large-diameter part 323 and faces the end 340T1 of the inner electrode 340. An outlet 332 is formed on the lamp-end side relative to a cylindrical section L2 and faces the exhaust tube 322. The length of the channel L4 is greater than the length of the cylindrical section L2 that corresponds to the length of the cylindrical segment 321K. Thus, ultraviolet can irradiate a gas or liquid in the channel R over the total of the channel R.

In the manufacturing process of the excimer lamp 310, a second glass tube corresponding to the exterior vessel 330 is temporarily supported by a flange formed on a first glass tube corresponding to the discharge vessel 320 and welded to the flange. Subsequently, a dielectric that covers a foil electrode and has a tapered segment is inserted into the first glass tube. The first glass tube is then welded to the tapered segment. Since the dielectric is welded to the first glass tube after the second glass tube is welded to the first glass tube, contamination by impurities in the discharge vessel 330 is suppressed.

The large diameter part 323 in the discharge vessel 320 may be welded to the tapered segment 361 in the dielectric 360. In this case, the diameter of the end 321T1 of the discharge vessel 320 is increased to match the large diameter part 323. The end 330T2 in the exterior vessel 330 may be welded to the shoulder segment 321R2 or the exhaust tube 322 of the discharge vessel 330.

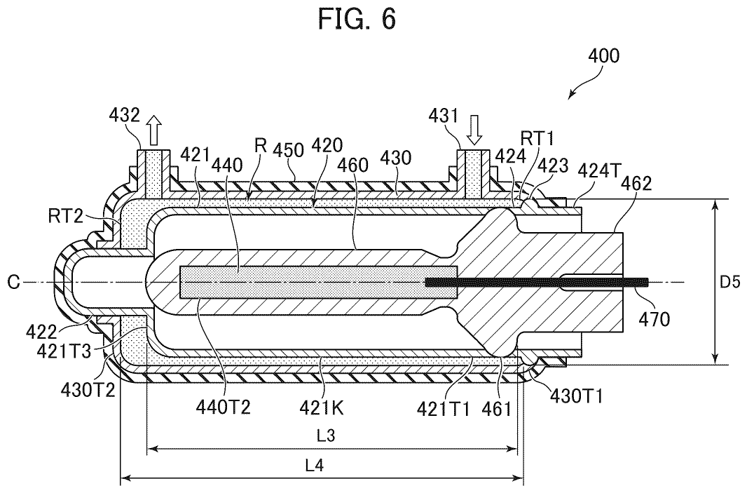

FIG. 6 is a cross-section view of an excimer lamp according to the fifth embodiment.

The excimer lamp 400 is equipped with a discharge vessel 420 and an exterior vessel 430. A dielectric 460, which covers an inner electrode 440, is coaxially arranged in the discharge vessel 420. The discharge vessel 420 has a tubular segment 421 and an exhaust tube 422. The dielectric 460 has a tapered segment 461 and an extending segment 462. The discharge vessel 420 and the exterior vessel 430 are covered with a reflective membrane 450.

The tubular segment 421 in the discharge vessel 420 has an extending segment 424 that extends over the tapered segment 461 along the lamp axis C. The extending segment 424 has a protrusion or flange 423 that protrudes radially (hereinafter, called a “large-diameter part”). The outer diameter and thickness of the large-diameter part 424 are greater than those of the other part.

One end 430T1 of the exterior vessel 430 is welded to the large diameter part 423 to form the channel end RT1. The other end 430T2 is welded to the exhaust tube 422 to form the channel end RT2.

In the exterior vessel 430, an inlet 431 is formed on the lamp-center side relative to the large diameter part 423 and faces the end 440T1 of the inner electrode 440. An outlet 432 is formed on the lamp-end side relative to the end 440T2 of the inner electrode 440 and faces the exhaust tube 422. The length of the channel L4 is greater than the length of the tubular section L3 and the channel R extends to the extending segment 462 of the dielectric 460. Ultraviolet light emitted from the discharge space S is transmitted to the channel end RT1 via the tapered segment 461 in the dielectric 460 and the large-diameter part 423 in the discharge vessel 420.

In the discharge vessel 420, the end 424T of the extending segment 424 is exposed, not covered with the reflective membrane 450. Thus, creeping discharge or dielectric breakdown is suppressed.

As for the extending segment 424 in the discharge vessel 420, another cylindrical tube may be welded to the end of discharge vessel 420. For example, a synthetic quartz glass with high transmittance of ultraviolet light may be used for the discharge vessel 420 and a fused quartz glass may be used for the extending segment 424. Alternatively, a thin quartz glass may be used for the discharge vessel 420 and a thick quartz glass may be used for the extending segment 424.

The end 421T1 of the discharge vessel 420 may be welded to the large diameter part 423 with the tapered segment 461 in the dielectric 460. In this case, the end 421T1 is made to be thick. The end 430T2 of the exterior vessel 430 may be welded to the shoulder segment 421R as shown in the first embodiment, or the cylindrical segment 421K as shown in the second embodiment.

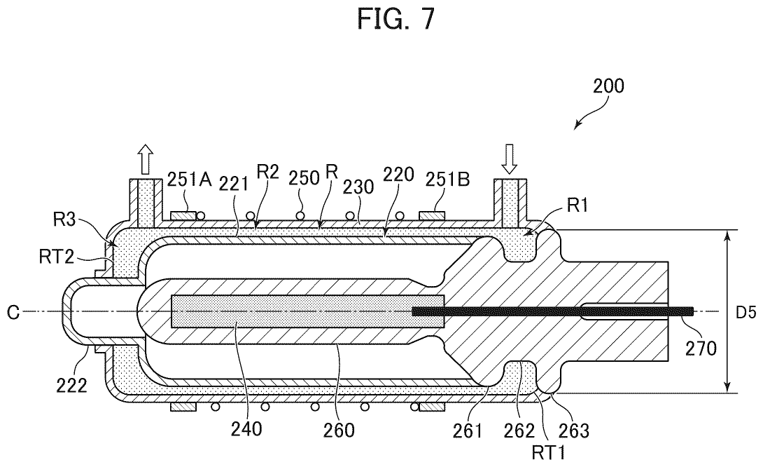

FIG. 7 is a cross-section view of an excimer lamp according to the sixth embodiment.

The excimer lamp 200 is the same as the excimer lamp 300 according to the second embodiment shown in FIG. 3, except for an outer electrode 250. The line-shaped outer electrode 250 is wound spirally around the outer surface of an exterior vessel 230 between a pair of cylindrical members 51A and 51B. Ultraviolet light emitted from a discharge vessel 320 passes through an extending segment 262 in the discharge vessel 320 and the inner wall of the exterior vessel 230. Consequently, a gas or liquid is effectively irradiated with ultraviolet light. The outer electrode may be applied to another embodiment.

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Application No. 2024-164317 (filed on Sep. 20, 2024), which is expressly incorporated herein by reference, in its entirety.

1. An excimer lamp comprising:
a tubular discharge vessel configured to form a discharge space; and
an exterior vessel configured to form a channel between said discharge vessel and said exterior vessel, at least one end of said channel being on a lamp-center side relative to an end of said discharge vessel in a lamp axis direction.

2. The excimer lamp according to claim 1, wherein said discharge vessel comprises a cylindrical segment along the lamp axis direction, at least one end of said channel is on the lamp-center side relative to an end of said cylindrical segment.

3. The excimer lamp according to claim 1, wherein a spatial distance in a radial direction of said channel is constant within said cylindrical segment.

4. The excimer lamp according to claim 3, wherein the distance is less than the thickness of said exterior vessel.

5. The excimer lamp according to claim 3, wherein the distance is set to a range between 0.2 mm to 2 mm.

6. The excimer lamp according to claim 1, further comprising a pair of electrodes, one electrode being arranged in said discharge vessel, the other electrode being arranged on or outside said exterior vessel, at least one end of said channel being outside of an electrode-opposing section.

7. The excimer lamp according to claim 1, further comprising an inner electrode in said discharge vessel, at least one end of said channel being on the lamp-end side relative to a corresponding end of said inner electrode.

8. The excimer lamp according to claim 1, wherein said discharge vessel comprises a cylindrical segment in the lamp axis direction, both ends of said channel being outside of said cylindrical segment in the lamp axis direction.

9. The excimer lamp according to claim 8, wherein the length of said channel is greater than that of said cylindrical segment.

10. The excimer lamp according to claim 1, wherein said exterior vessel is welded to said discharge vessel, a welded part being next to the channel end, the welded part being on the lamp-center side relative to the end of said discharge vessel.

11. The excimer lamp according to claim 10, wherein said discharge vessel comprises a large-diameter part configured to be thicker than the other part of the discharge vessel, said exterior vessel being welded to said large-diameter part.

12. The excimer lamp according to claim 10, wherein said large-diameter part is formed adjacent to the tip surface of said discharge vessel.

13. The excimer lamp according to claim 10, wherein said discharge vessel comprises an exhaust tube, said exterior vessel being welded to or adjacent to said exhaust tube.

14. The excimer lamp according to claim 10, further comprising:
an inner electrode in said discharge vessel; and
a dielectric configured to cover said inner electrode, said dielectric comprising a tapered segment configured to enlarge a diameter radially, said exterior vessel being welded adjacent to the end of said tapered segment.

15. The excimer lamp according to claim 10, further comprising an outer electrode, said electrode comprising a reflective membrane configured to cover the outer surface of said exterior vessel and extends over the welded part toward the lamp-end side.
